(19) United States
(12) Patent Application Publication
(10) Pub. No.: US 2013/0132669 A1
(43) Pub. Date: May 23, 2013

(54) METHOD FOR CONTROLLING THE SINGLE-AFFILIATION SERIAL ADVANCED TECHNOLOGY ATTACHMENT DRIVER OF ACTIVE-ACTIVE REDUNDANT ARRAY OF INDEPENDENT DISKS AND SYSTEM THEREOF

(71) Applicants: Xu-Ming ZHANG, Tianjin (CN); Chih-Feng CHEN, Taipei (TW)

(72) Inventors: Xu-Ming ZHANG, Tianjin (CN); Chih-Feng CHEN, Taipei (TW)

(73) Assignee: INVENTEC CORPORATION, Taipei (TW)

(21) Appl. No.: 13/430,814

(22) Filed: Mar. 27, 2012

(30) Foreign Application Priority Data
Nov. 23, 2011 (CN) 201110390635.3

(51) Int. Cl. G06F 12/00

(52) U.S. Cl. 711/114; 711/E12.001

(57) ABSTRACT

A method for controlling a single-affiliation serial advanced technology attachment (SATA) driver of an active-active redundant array of independent disks (RAID) and a system thereof are described. The method includes a first control device assembly traversing a local access path for determining whether the local access path is capable of being connected to an SATA device; if the local access path is damaged, the first control device assembly being connected to a second lock module; determining whether a first lock module or the second lock module obtains an access authority to the SATA device according to a time-sharing mechanism; and when the first lock module obtains the access authority, a first RAID controller being connected to the second control device assembly and accessing the SATA device by a remote access path lock module.

### CROSS-REFERENCE TO RELATED APPLICATIONS

This non-provisional application claims priority under 35 U.S.C. §119(a) on Patent Application No(s). 201110390635.3 filed in China, P.R.C. on Nov. 23, 2011, the entire contents of which are hereby incorporated by reference.

### BACKGROUND

1. Technical Field

The present disclosure relates to a method for controlling a hardware driver and a system thereof, and more particularly to a method for controlling a single-affiliation serial advanced technology attachment (SATA) driver of an active-active redundant array of independent disks (RAID) and a system thereof.

2. Related Art

With development of networks, a storage device is developed from a single machine to a network storage. The network storage may be implemented by serial attached small computer system interface (SAS), Internet small computer system interface (iSCSI), fibre storage area network (SAN), or network attached storage (NAS). The above network storage may also be combined with other storage devices, for example, implementing a RAID in the SAS.

FIG. 1 is an architecture view of an active-active RAID system in an SATA in the related art. Referring to FIG. 1, the host ends 111 and 112 send document access requests for an SATA device 140 to an RAID control device 120. The RAID control device 120 comprises a first RAID controller 121 and a second RAID controller 122. The RAID controller 121 and the second RAID controller 122 process the document access requests for the SATA device 140 respectively from the host end 111 and the host end 112.

When the RAID control device 120 visits the SATA device 140, the RAID control device 120 is connected to the SATA device 140 by corresponding expanders. As shown in FIG. 1, the first RAID controller 121 is connected to the SATA device 140 by a first expander 131 and a second expander 132. According to a serial advanced technology attachment tunneling protocol (STP), data is transmitted between the host ends and the SATA device 140 by three types of affiliation transmission, i.e., no affiliations, multiple affiliations, and single affiliation.

When the SATA device 140 is in operation, the SATA device 140 may have an alteration (for example, adding an SAS disk, removing an SAS disk, and interrupting an interlink between the expanders), so the RAID controller has to adjust a topology to the SATA device 140 for an access. In other words, the RAID controller has to update the access path to the SATA device 140.

If using an expander having no-affiliations transmission function, the first RAID controller 121 cannot connect to the SATA device 140 by the expanders of the second RAID controller 122, and vice versa. If using an expander having multiple-affiliation transmission function, the first RAID controller 121 may be connected to a third expander 133 and a fourth expander 134 by the first expander 131, and thus connected to the SATA device 140. In other words, the first RAID controller 121 may perform data access on the SATA device 140 by two different access paths at the same time. A single-affiliation expander can perform the data access by only one of the two access paths.

The manufacturing cost of the expander having multiple-affiliation transmission function is much higher than that of other types of the expanders, and therefore not all the active RAID systems are configured with the expander having multiple-affiliation transmission function

### SUMMARY

The system for controlling the single-affiliation SATA driver of the active RAID according to the present disclosure comprises a host end, a first control device assembly, a second control device assembly, and an SATA device. The host end sends a file access request to the first control device assembly or the second control device assembly for obtaining a corresponding data file from the SATA device. The first control device assembly comprises a first RAID controller, a first lock module, and a plurality of first SAS expanders. The second control device assembly comprises a second RAID controller, a second lock module, and a plurality of second SAS expanders.

The first RAID controller further comprises a first lock module. The plurality of first SAS expanders is serially connected to an access path. Two ends of the access path are respectively connected to the first RAID controller and the SATA device. The second RAID controller further comprises a second lock module. The plurality of second SAS expanders is serially connected to form another access path. Two ends of the access path are respectively connected to the second RAID controller and the SATA device. The first lock module is connected to the second lock module by an inner link manner. The first expander is connected to the second expander by an inter-link.

When the first control device assembly determines that the local access path cannot be connected to the SATA device, the first control device assembly sends the device alteration request. The first control device assembly is connected to the second lock module of the second control device assembly by the first lock module. The first lock module and the second lock module determine a sequence of obtaining an access authority to the SATA device according to a time-sharing mechanism. After the first RAID controller obtains the access authority to the SATA device, the first RAID controller is connected to the SATA device by a remote access path by the second expander.

The present disclosure further provides a method for controlling an SATA driver of an active RAID, the method comprising: a first control device assembly traversing a local access path formed by connecting a plurality of first SAS expanders, for determining whether the local access path is capable of being connected to an SATA device; if the local access path is damaged, the first control device assembly sending a device alteration request, and the first control device assembly being connected to a second lock module of a second control device assembly by a first lock module; determining whether the first lock module or the second lock module obtains an access authority to the SATA device according to a time-sharing mechanism; and when the first lock module obtains the access authority to the SATA device, a first RAID controller of the first control device assembly being connected to the second control device assembly by the first SAS expander and an interlink, and accessing the SATA device by a remote access path formed by connecting a plurality of second lock modules in the second control device assembly.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic view of architecture of an active RAID system in an SATA in the conventional art;

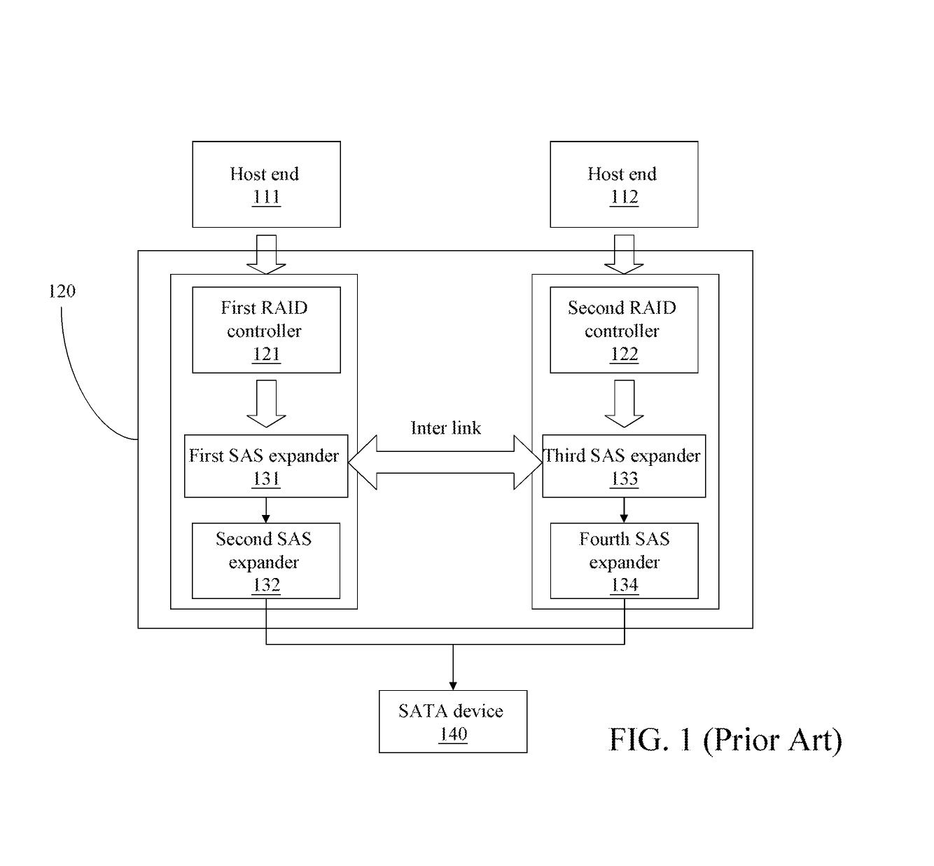

FIG. 2 is an architecture view of the present disclosure;

FIG. 3 is a schematic view of an operation flowchart of the present disclosure;

FIG. 4A is a main operation flowchart of the present disclosure;

FIG. 4B is a detailed operation flowchart of the present disclosure;

FIG. 4C is another detailed operation flowchart of the present disclosure;

FIG. 4D is a schematic view of a local access path of the present disclosure; and

FIG. 4E is a schematic view of a remote access path of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The present disclosure provides a system for controlling a single-affiliation SATA driver of an active RAID, which is adapted to transmission to an SATA device having a single-affiliation transmission function in a SAS architecture, so that different RAID controllers may adjust a topology to the SATA device according to a device alteration request of the SATA device.

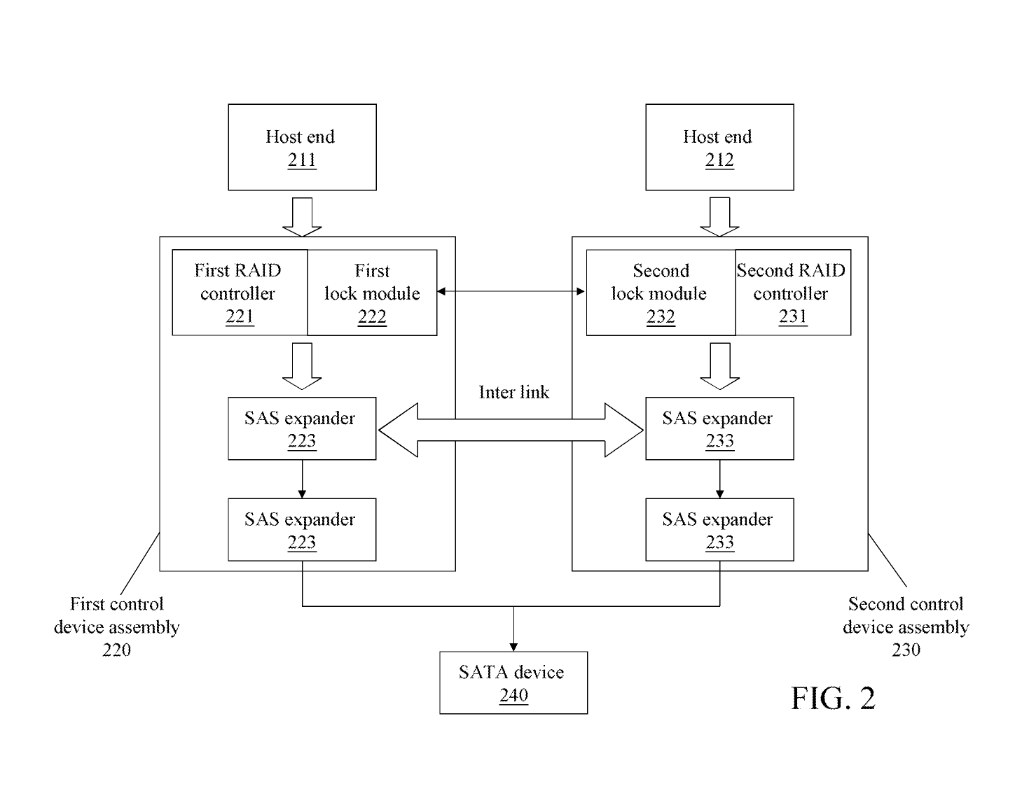

The present disclosure is applied to a single-affiliation active-active RAID system. FIG. 2 is an architecture view of the present disclosure. Referring to FIG. 2, the control system of the present disclosure comprises host ends 211 and 212, a first control device assembly 220, a second control device assembly 230, and an SATA device 240.

The first control device assembly 220 and the second control device assembly 230 are connected to the respective host ends 211 and 212. The host ends 211 and 212 send document access requests to the control device assemblies 220 and 230 so as to obtain corresponding data files from the SATA device 240. The first control device assembly 220 comprises a first RAID controller 221, a first lock module 222, and a plurality of first SAS expanders 223. The second control device assembly 230 comprises a second RAID controller 231, a second lock module 232, and a plurality of second SAS expanders 233.

The first RAID controller 221 is connected to the first lock module 222. The plurality of first SAS expanders 223 are serially connected, and form a serial path. Two ends of the serially connected first SAS expanders 223 are respectively connected to the first RAID controller 221 and the SATA device 240. Data transmission between the expanders is implemented through an interlink specified by the STP protocol. For an STP protocol, the first RAID controller 221 and the first SAS expander 223 perform physical data transmission through respective connection ports. The expanders and the SATA device 240 perform the data transmission through respective connection ports.

Similarly, for the second control device assembly 230, the second SAS expanders 233 of the second control device assembly 230 are serially connected through an interlink. Two ends of the serially connected second SAS expanders 233 are respectively connected to the second RAID controller 231 and the SATA device 240. The number of the SATA devices 240 in the present disclosure is not limited. One single SATA device is shown in FIG. 2 just for illustration, but the present disclosure is not limited thereto.

In order to differentiate access paths from different control device assemblies to the SATA device, the present disclosure further defines two types of access paths, i.e., a local access path and a remote access path. The local access path refers to a channel through which the RAID controller is connected to the SATA device 240 by the local SAS expanders. The remote access path refers to a channel through which the RAID controller is connected to the SATA device 240 through the SAS expanders of the other control device assembly.

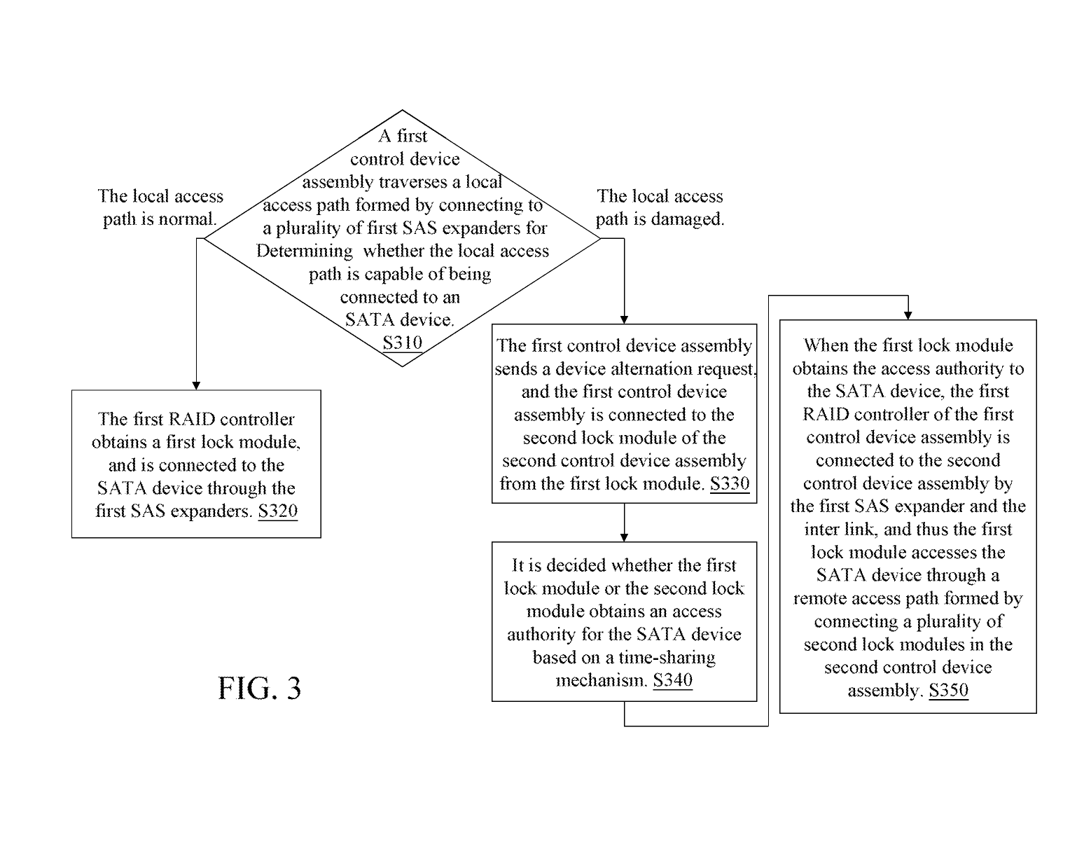

In order to clearly describe a general operation manner of the present disclosure, FIG. 3 illustrates a flowchart for the operation of an embodiment of the present disclosure. The control method of the present disclosure comprises the following steps.

Step S310: A first control device assembly traverses a local access path formed by connecting a plurality of first SAS expanders for determining whether the local access path is capable of being connected to an SATA device.

Step S320: If the local access path is normal, the first RAID controller obtains a first lock module, and is connected to the SATA device through the first SAS expanders.

Step S330: If the local access path is damaged, the first control device assembly sends a device alteration request, and the first control device assembly is connected to the second lock module of the second control device assembly from the first lock module of the first control device assembly.

Step S340: It is determined whether the first lock module or the second lock module obtains an access authority to the SATA device based on a time-sharing mechanism.

Step S350: When the first lock module obtains the access authority to the SATA device, the first RAID controller of the first control device assembly is connected to the second control device assembly by the first SAS expander and the interlink, and thus the first lock module accesses the SATA device through a remote access path formed by connecting a plurality of second lock modules in the second control device assembly.

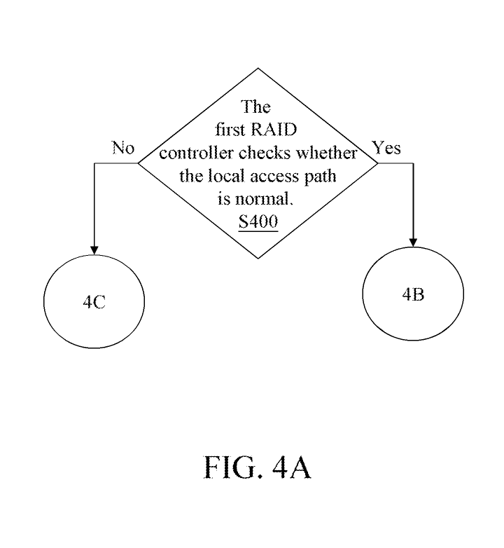

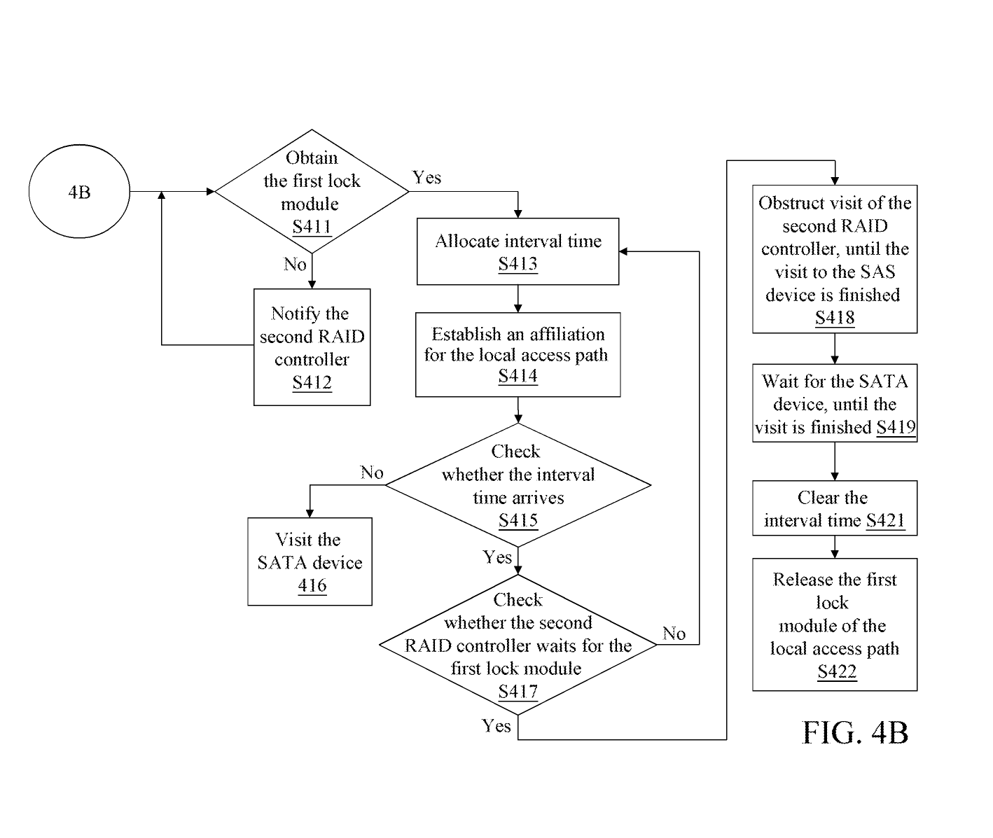

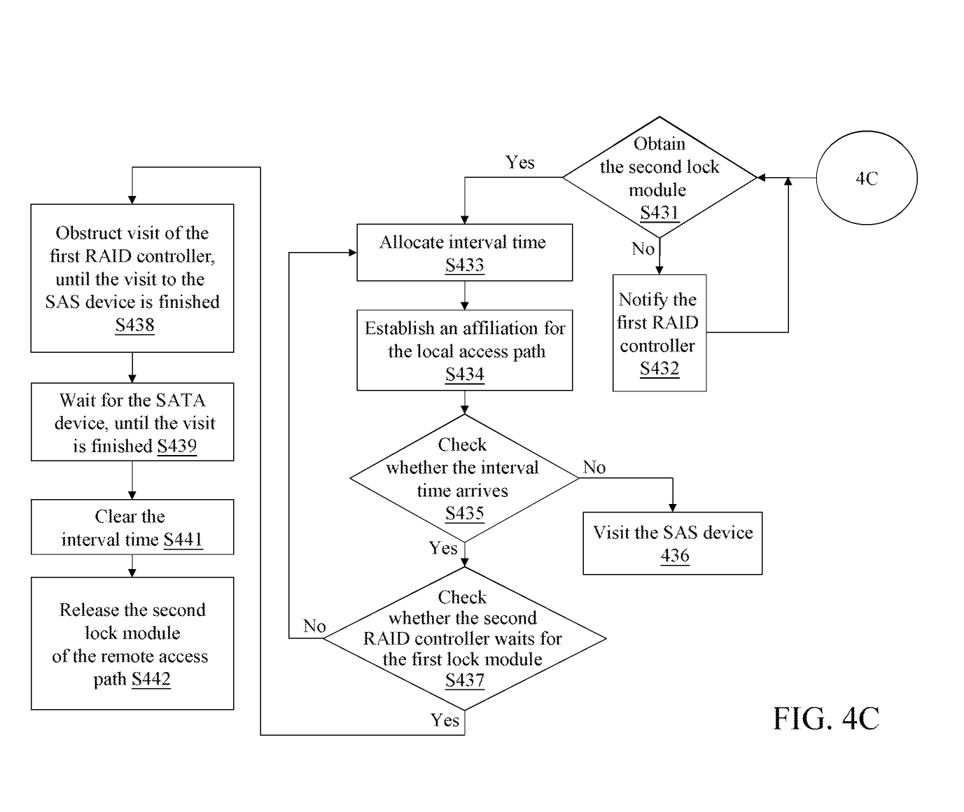

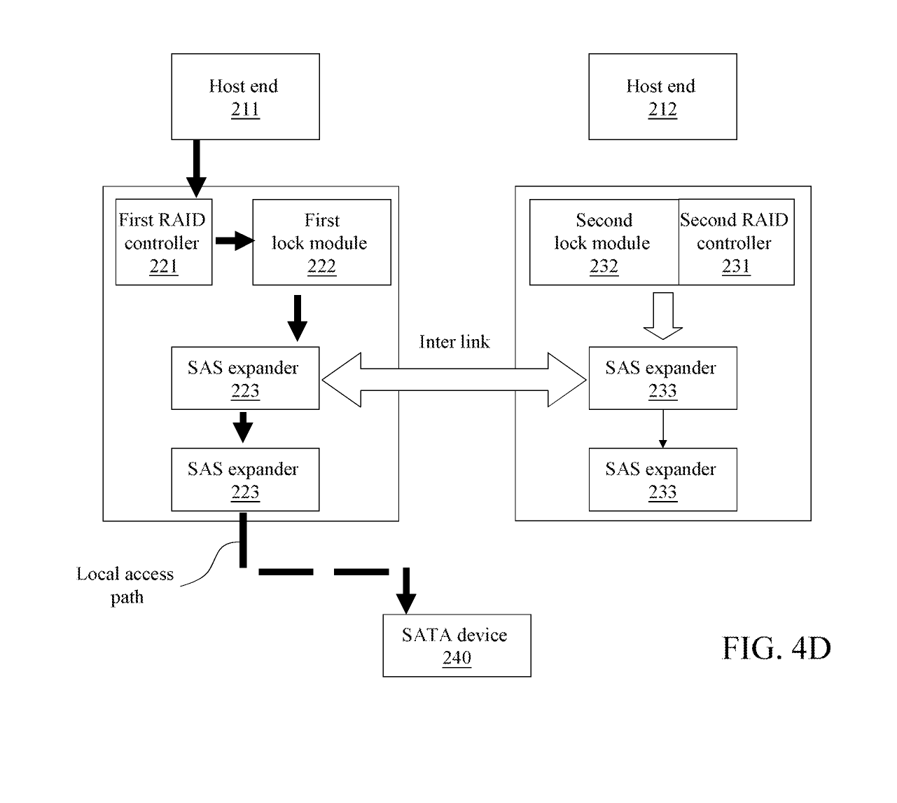

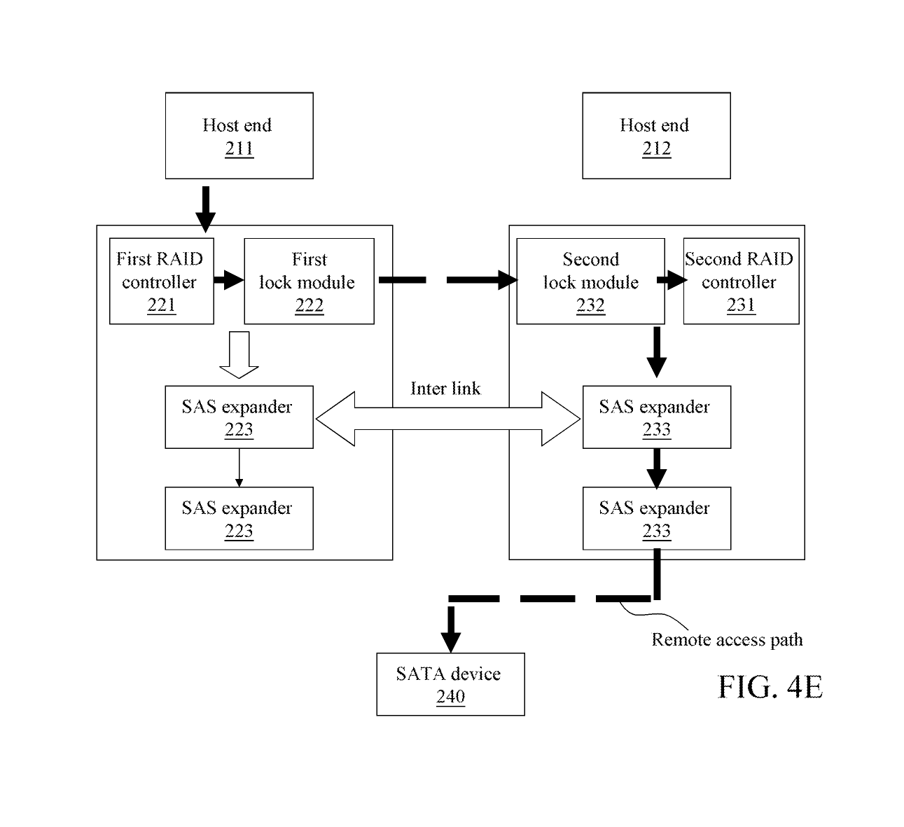

In order to further describe operation of the present disclosure, take the first RAID controller 221 for illustration, the access path of the first RAID controller 221 by the first control device assembly 220 is considered to be the local access path, and the access path of the first RAID controller 221 by the second RAID control device assembly is the remote access path. The operation will be described in detail below with reference to FIG. 4A, FIG. 4B, FIG. 4C, FIG. 4D, and FIG. 4E.

The first RAID controller 221 firstly traverses all the first SAS expanders 223 of the first control device assembly 220, and determines whether all the first SAS expanders 223 are damaged (corresponding to Step S310 in FIG. 3 and S400 in FIG. 4A). When all the serially connected first SAS expanders 223 are normal, the first RAID controller 221 obtains the first lock module 222 (corresponding to Step S320 in FIG. 3 and S411 in FIG. 4B), and the first RAID controller 221 establishes an affiliation with the first lock module 222 (corresponding to Step S320 in FIG. 3 and S414 in FIG. 4B), for prohibiting other RAID controllers from accessing the first SAS expanders 223 (corresponding to Step S320 in FIG. 3 and S418 in FIG. 4B). The first RAID controller 221 is connected to the SATA device 240 through the first SAS expanders 223 (corresponding to S416 in FIG. 4B). If the local access path is normal, the first RAID controller 221 is connected to the SATA device 240 through the first SAS expanders 223. The black dashed line in FIG. 4D is used to denote the local access path. After the first RAID controller 221 visits the SATA device 240, the first RAID controller 221 releases the first lock module 222, so that another RAID controller may visit the SATA device 240 (corresponding to Step S350 in FIG. 3 and S422 in FIG. 4B).

If any one of the first SAS expanders 223 is damaged, the first RAID controller 221 may receive a response when traversing each expander 223. Furthermore, the first RAID controller 221 is connected to the second lock module 232 by the first lock module 222. The first lock module 222 is connected to the second lock module 232 through a interlink. The interlink connected with the first lock module 222 and the interlink connected with the SAS expander belong to different transmission paths, so the transmission by the two interlink will not interfere with each other. Subsequently, the first RAID controller 221 obtains the second lock module 232 (corresponding to Step S330 of FIG. 3 and the flowchart in FIG. 4C).

Assuming that the first RAID controller 221 obtains the control of the second SAS expander 233, the first RAID controller 221 may be connected to the SATA device 240 by the second SAS expanders 233. For the first RAID controller 221, the access path by the second control device assembly 230 is the remote access path which is shown by the black dashed line in FIG. 4E.

When the RAID controller of the present disclosure obtains the lock module, the RAID controller may allocate the access authority of the RAID controller according to a time-sharing mechanism. The time-sharing mechanism is performed by timing operations of each RAID controller to prevent that after visiting the SATA device 240, the RAID controller still holds the access authority, leading that other RAID controllers cannot access the SATA device 240.

Referring to FIG. 4B, after the first RAID controller 221 obtains the first lock module 222, the first RAID controller 221 counts backwards for a time interval (corresponding to Step S340 in FIG. 3 and S413 in FIG. 4B). When the time interval ends, the first RAID controller 221 detects whether another RAID controller sends a request for using the first lock module 222 (corresponding to Step S340 in FIG. 3 and S415 in FIG. 4B). When the time interval ends and the first RAID controller 221 receives the request for using the first lock module 222 from another RAID controller, the first RAID controller 221 releases the affiliation with the first lock module 222 as well as the access authority to the SATA device 240 (corresponding to Step S340 in FIG. 3 and S417 in FIG. 4B). If after the time interval, the first RAID controller 221 still accesses the SATA device 240, the first RAID controller 221 holds the access authority to the SATA device 240. Otherwise, the first RAID controller 221 resets the time interval (corresponding to Step S340 in FIG. 3 and S421 in FIG. 4B).

The above mentioned time-sharing mechanism is for the local access path, and it is also adaptive for the remote access path. After obtaining the second lock module 232, the first RAID controller 221 establishes the affiliation with lock module. After the time interval, if no RAID controller sends a request for using the second lock module 232, the first RAID controller 221 decides whether to release the access authority depending on its access need for the SATA device 240.

The above description is not limited to the first RAID controller 221 but also for the second RAID controller 231. The access path from the second RAID controller 231 to the SATA device 240 by the second SAS expander 233 is considered to be the local access path, and the access path by the first control device assembly 220 is considered to be the remote access path. The operation of the second RAID controller 231 for accessing the SATA device 240 by the local path and the remote path is shown by Steps S431-S442 of FIG. 4C.

The method for controlling the SATA driver of an active RAID and the system thereof according to the present disclosure adjust the topology to the SATA device 240 according to a device change request. In the present disclosure, the first RAID controller 221 or the second RAID controller 231 may dynamically adjust an access path to the SATA device 240 without the SATA device 240 having a multiple-affiliation transmission function.

What is claimed is:

1. A system for controlling a single-affiliation serial advanced technology attachment (SATA) driver of an active-active redundant array of independent disks (RAID), for adjusting a topology to the SATA device according to a device alteration request, the control system comprising:
a first control device assembly connected to the SATA device for receiving the device alteration request, and the first control device assembly comprising:
a first RAID controller for determining whether to access the SATA device by a local access path or a remote access path;
a first lock module connected to the first RAID controller; and
at least one first SAS expander serially connected with each, wherein one first SAS expander is connected to the first RAID controller, and another first SAS expander is connected to the SATA device, and the first SAS expanders are; and
a second control device assembly connected to the SATA device for receiving the device alteration request, and the second control device assemble comprising:
a second RAID controller for determining whether to access the SATA device through the local access path or the remote access path;
a second lock module connected to the second RAID controller and the first lock module; and
at least one second SAS expander serially connected with each other, wherein one second SAS expander is connected to the second RAID controller, and the other second SAS expander is connected to the SATA device, and each first SAS expander is connected to the corresponding second SAS expander through an inter-expander SAS link,
wherein the first lock module and the second lock module is configured to obtain an access authority to the SATA device according to a time-sharing mechanism and determine whether to use the local access path or the remote access path to the SATA device.

2. The system for controlling a single-affiliation SATA driver of an active RAID according to claim 1, wherein the local access path of the first control device assembly is a path to the SATA device by the first RAID controller and the first SAS expanders, and the remote access path of the first control device assembly is a path to the SATA device by the first RAID controller and the second SAS expanders.

3. The system for controlling a single-affiliation SATA driver of an active RAID according to claim 1, wherein the local access path of the second control device assembly is a path to the SATA device by the second RAID controller and the second SAS expanders, and the remote access path of the second control device assembly is a path to the SATA device through the second RAID controller and the first SAS expanders.

4. The system for controlling a single-affiliation SATA driver of an active RAID according to claim 1, wherein the time-sharing mechanism is an access authority to the SATA device in a time interval obtained by the first RAID controller or the second RAID controller.

5. A method for controlling a single-affiliation serial advanced technology attachment (SATA) driver of an active-active redundant array of independent disks (RAID), for adjusting a topology to an SATA device according to a device alteration request, the control method comprising:
a first control device assembly traversing a local access path connected to a plurality of first SAS expanders, for determining whether the local access path is capable of being connected to the SATA device;
if the local access path is damaged, the first control device assembly sending the device alteration request, and the first control device assembly being connected to a second lock module of a second control device assembly by a first lock module;
determining whether to use the first lock module or the second lock module to obtain an access authority to the SATA device according to a time-sharing mechanism; and
when the first lock module obtains the access authority to the SATA device, a first RAID controller of the first control device assembly being connected to the second control device assembly by the first SAS expander and an interlink, and accessing the SATA device by a remote access path formed by connecting a plurality of second lock modules in the second control device assembly.

6. The controlling a single-affiliation SATA driver of an active RAID according to claim 5, wherein if the local access path is not damaged, the first control device assembly is connected to the SATA device by the local access path to access the SATA device.

7. The controlling a single-affiliation SATA driver of an active-active redundant array of independent disks (RAID) according to claim 5, wherein the time-sharing mechanism comprises:
when the first lock module obtains the access authority, the first lock module determines after a time interval whether the second lock module sends a request for using the access authority to the SATA device;
if the second lock module requests the access authority lock module, the first lock module transfers the access authority to the SATA device to the second lock module; and
if the second lock module does not request the access authority lock module, the first lock module recounts another time interval.
